(19) United States
(12) Patent Application Publication
(10) Pub. No.: US 2012/0111160 A1
(43) Pub. Date: May 10, 2012

(54) Isolative Torque-Exerting Apparatus for Easy Maintenance

(76) Inventor: Jih Chun WU, Taichung City (TW)

(21) Appl. No.: 12/941,051

(22) Filed: Nov. 6, 2010

(51) Int. Cl. B25B 23/142

(52) U.S. Cl. 81/467

(57) ABSTRACT

An isolative torque-exerting apparatus includes a wrench, a torque unit located in the wrench, and an isolative unit provided on the wrench. The isolative unit includes a hatch defined therein and a cover for covering the hatch. The torque unit can be tuned by a tool inserted through the hatch.

### BACKGROUND OF INVENTION

1. Field of Invention

The present invention relates to an isolative torque-exerting apparatus and, more particularly, to an isolative torque-exerting apparatus that is used to exert an adjustable maximum value of torque and can easily be tuned.

2. Related Prior Art

As disclosed in Taiwanese Patent Publication No. 404306, a socket wrench includes a handle coated with an isolative unit 11, and so is a socket. The isolative units 11 protect a user from an electric shock.

There are adjustable-torque socket wrenches. An adjustable-torque socket wrench is equipped with a torque unit operable to adjust a maximum value of torque that can be exerted through the adjustable-torque socket wrench. There is however a problem with providing adjustable-torque socket wrenches with isolative units 11. The torque units are tested and, more particularly, calibrated before the adjustable-torque socket wrenches are delivered. The isolative units 11 deny access to the torque units. Some of the adjustable-torque socket wrenches that are proven to include problematic torque units cannot be corrected and must be dumped. This is a waste, and entails high costs in making such isolative adjustable-torque socket wrenches.

The present invention is therefore intended to obviate or at least alleviate the problems encountered in prior art.

### SUMMARY OF INVENTION

It is the primary objective of the present invention to provide an isolative torque-exerting apparatus which can easily be tuned without compromising the isolation of the torque-exerting apparatus.

To achieve the foregoing objective, the isolative torque-exerting apparatus includes a wrench, a torque unit located in the wrench, and an isolative unit provided on the wrench. The isolative unit includes a hatch defined therein and a cover for covering the hatch. The torque unit can be tuned by a tool inserted through the hatch.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of an isolative torque-exerting apparatus according to the first embodiment of the present invention;

FIG. 2 is a partial, partial view of the isolative torque-exerting apparatus shown in FIG. 1; and

FIG. 3 is an exploded view of an isolative torque-exerting apparatus according to the second embodiment of the present invention.

### DETAILED DESCRIPTION OF EMBODIMENTS

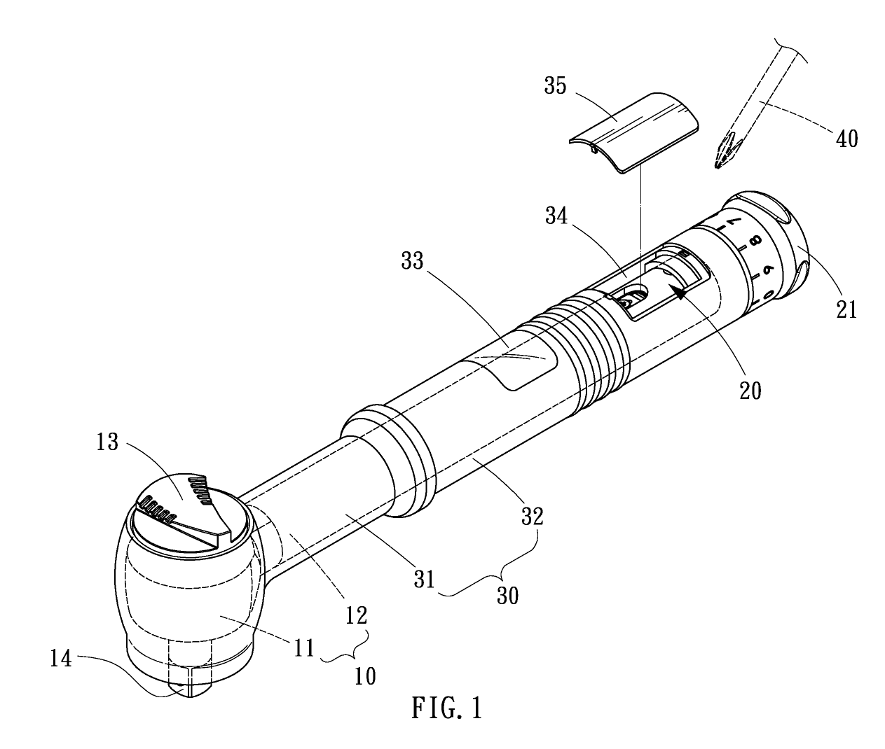

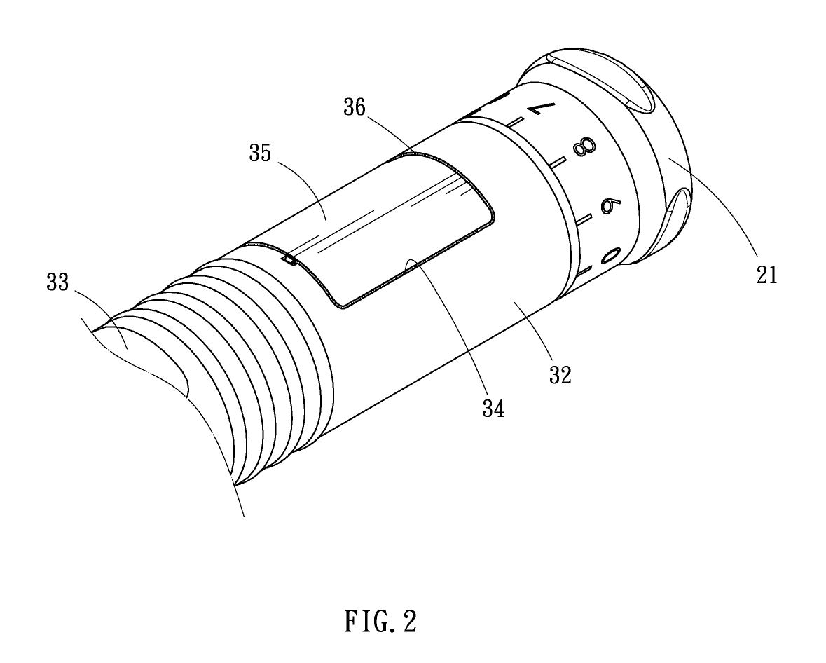

Referring to FIGS. 1 and 2, there is shown an isolative torque-exerting apparatus according to a first embodiment of the present invention. The isolative torque-exerting apparatus includes a wrench 10, a torque unit 20 located in the wrench 10, and an isolative unit 30 provided on the wrench 10. The wrench 10 includes a head 11 formed at an end of a handle 12. A selective one-way driving unit is located in the head 11. The selective one-way driving unit is not described in detail for not being the spirit of the present invention. A switch 13 is located on an upper side of the head 11 and connected to the selective one-way driving unit. The switch 13 is made of an isolative material such as plastics. A square insert 14 is located on a lower side of the head 11 and connected to the selective one-way driving unit. By turning the switch 13, the handle 12 can be pivoted to spin the square insert 14 in a selected one of two directions through the selective one-way driving unit. The handle 12 includes a hatch defined therein.

The torque unit 20 is located in the handle 12. A knob 21 is rotationally connected to an opposite end of the handle 12 and connected to the torque unit 20. By turning the knob 21, the maximum value of torque to be exerted through the wrench 10 is adjusted. The precision of the torque unit 20 could be reduced after some time of use. In this case, a tool 40 can be inserted into the handle 12 through the hatch of the handle 12 and used to operate the torque unit 20 to correct the torque unit 20.

The isolative unit 30 includes two isolative elements 31 and 32 both made of an isolative material such as plastics. The first isolative element 31 covers the head 11 but not the switch 13 and the square insert 14. Hence, the first isolative element 31 does not interfere with the operation of the switch 13 and the square insert 14. Furthermore, the first isolative element 31 covers a portion of the handle 12. The second isolative element 32 covers the remaining portion of the handle 12. The first isolative element 31 covers a portion of the second isolative element 31 or the second isolative element 32 covers a portion of the first isolative cover 31. A window 33 is defined in the second isolative element 32. The window 33 is covered with a lens. Thus, the torque unit 20 and a portion of the tool 40 are visible through the window 33. A hatch 34 is defined in the second isolative element 32 and aligned with the hatch of the handle 12. The hatch 34 can be covered with a cover 35 which is made of an isolative material such as plastics. The cover 35 is buckled onto the second isolative element 32. Isolative paste or glue is provided between the edge of the hatch 34 and that of the cover 35.

To tune the torque unit 20, the cover 35 is advantageously detached from the second isolative element 32, opening the hatch 34 of the second isolative element 32 and the hatch of the handle 12. The tool 40 is inserted into the handle 12 through the hatch 34 of the second isolative element 32 and the hatch of the handle 12 and used to tune the torque unit 20. After the tuning, the cover 35 is attached to the second isolative element 32 again. As discussed above, the torque unit 20 is tuned without having to break the isolative unit 30.

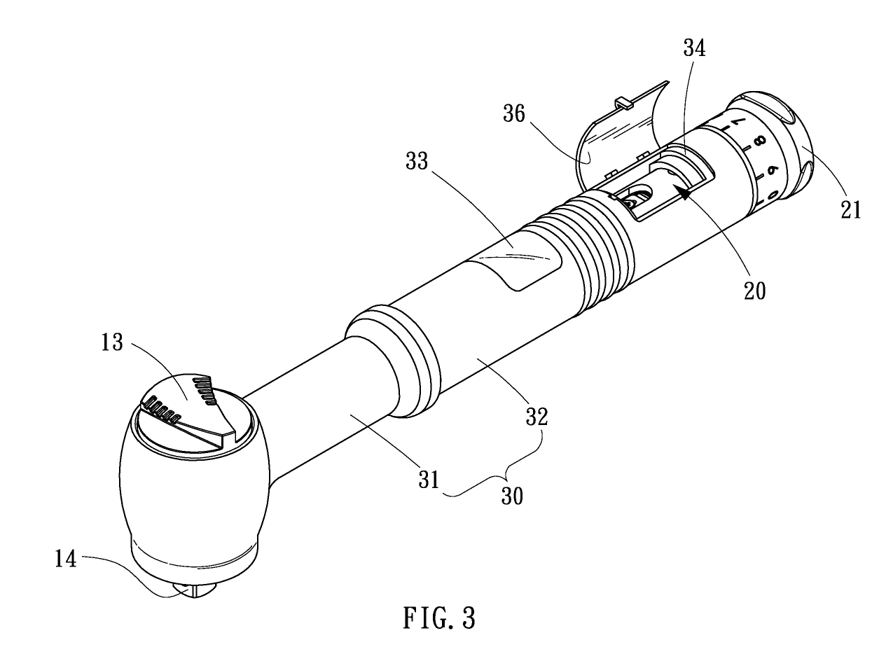

Referring to FIG. 3, there is shown an isolative torque-exerting apparatus according to a second embodiment of the present invention. The second embodiment is identical to the first embodiment except including a door 36 instead of the cover 35. The door 36 is pivotally connected to the second isolative element 32 by at least one hinge for example.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An isolative torque-exerting apparatus including:
a wrench;
a torque unit located in the wrench; and
an isolative unit provided on the wrench, wherein the isolative unit includes:
a hatch defined therein so that the torque unit can be tuned by a tool inserted through the hatch; and
a cover for covering the hatch.

2. The isolative torque-exerting apparatus according to claim 1, wherein the isolative unit includes a first isolative element for covering a portion of the wrench and a second isolative element for covering the remaining portion of the wrench.

3. The isolative torque-exerting apparatus according to claim 1, including isolative paste provided between the edge of the hatch and that of the cover.

4. The isolative torque-exerting apparatus according to claim 3, wherein the cover is buckled onto the isolative unit.

5. The isolative torque-exerting apparatus according to claim 3, wherein the cover is pivotally connected to the isolative unit.
